(19) United States
(12) Patent Application Publication
(10) Pub. No.: US 2009/0300659 A1
(43) Pub. Date: Dec. 3, 2009

(54) Device Managing System and Program

(75) Inventor: Norihiko ASAI, Tajimi-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/412,848

(22) Filed: Mar. 27, 2009

(30) Foreign Application Priority Data
May 28, 2008 (JP) 2008-139301

(51) Int. Cl. G06F 9/44

(52) U.S. Cl. 719/321

(57) ABSTRACT

A device managing system, includes: a storage unit configured to store management information on at least two devices, the management information including at least one of a history of utilizing as a default device, specification, and a record of use; a determination unit configured to acquire the management information, and configured to determine a default candidate from the devices based on an indicator included in the acquired management information; and a setting unit configured to set the determined default candidate as a default device.

### CROSS-REFERENCE TO RELATED APPLICATION

This application claims priority from Japanese Patent Application No. 2008-139301 filed on May 28, 2008, the entire subject matter of which is incorporated herein by reference.

### TECHNICAL FIELD

Aspects of the present invention relate to device a managing system and a program capable of performing a default setting for a usually used printer (default printer). More particularly, aspects of the present invention relate to a device managing system and a program capable of conveniently setting a proper default device.

### BACKGROUND

An information processing apparatus such as a personal computer (PC) can be connected to plural devices. Accordingly, plural drivers corresponding to the devices are installed in the information processing apparatus, In the information processing apparatus in which the plural drivers are installed, for example, a printer (so-called in-use printer or default printer) used when a program designates no printer and a print command is selected may be set.

In the above-mentioned information processing apparatus, at the time of uninstalling the printer driver of the printer designated as the default printer, it is necessary to newly set a default printer. For example, JP-A-2004-287764 discloses a related-art method of uninstalling a printer driver in which when the default printer is to be uninstalled, after the default printer is uninstalled, a user is made to select a printer as a default printer.

However, the above-mentioned related-art device managing system has the following problem. That is, the behavior of selecting the default printer is left to a user's determination. Accordingly, when it is intended to select a proper printer from plural printers, the user has to have information required for the determination. Therefore, a burden is imposed on the user.

### SUMMARY

Exemplary embodiments of the present invention address the above disadvantages and other disadvantages not described above. However, the present invention is not required to overcome the disadvantages described above, and thus, an exemplary embodiment of the present invention may not overcome any of the problems described above.

Accordingly, it is an aspect of the invention to provide a device managing system and a program capable of simply setting a proper default device.

According to an exemplary embodiment of the present invention, there is provided a device managing system, comprising: a storage unit configured to store management information on at least two devices, the management information including at least one of a history of utilizing as a default device, specification, and a record of use; a determination unit configured to acquire the management information, and configured to determine a default candidate from the devices based on an indicator included in the acquired management information; and a setting unit configured to set the determined default candidate as a default device.

According to another exemplary embodiment of the present invention, there is provided a device managing system comprising: a storage unit configured to store management information on at least two devices, the management information including at least one of a history of utilizing as a default device, specification, and a record of use; a selection unit configured to acquire the management information, and configured to display identification information of the devices together with the management information, the selection unit configured to select one of the devices; and a manual setting unit configured to set the selected one of the devices as the default device.

According to another exemplary embodiment of the present invention, there is provided a computer-readable medium having a computer program stored therein and readable by a computer, the computer program, when executed by the computer, causing the computer to perform operations comprising: acquiring the management information on at least two devices, the management information including at least one of a history of utilizing as a default device, specification, and a record of use; determining a default candidate from the devices based on an indicator included in the acquired management information; and setting the determined default candidate as a default device.

According to another exemplary embodiment of the present invention, there is provided a computer-readable medium having a computer program stored therein and readable by a computer, the computer program, when executed by the computer, causing the computer to perform operations comprising: acquiring the management information on at least two devices, the management information including at least one of a history of utilizing as a default device, specification, and a record of use; displaying identification information of the devices together with the management information; selecting one of the devices; and setting the selected one of the devices as the default device.

### BRIEF DESCRIPTION OF THE DRAWINGS

The above and other aspects of the present invention will become more apparent and more readily appreciated from the following description of exemplary embodiments of the present invention taken in conjunction with the attached drawings, in which:

FIG. 1 is a block diagram illustrating a configuration of a device managing system according to an embodiment of the invention;

FIG. 2 is a block diagram illustrating a PC included in the device managing system according to the embodiment;

FIG. 3 is a diagram illustrating an example of a database storing print history;

FIG. 4 is a diagram illustrating an example of a database storing default history;

FIG. 5 is a flowchart illustrating a sequence of operations of an installer according to the embodiment;

FIG. 6 is a flowchart illustrating a sequence of operations of an uninstaller according to the embodiment;

FIG. 7 is a diagram illustrating an example of notification at the time of changing a default printer;

FIG. 8 is a diagram illustrating an example of a selection screen for selecting a new default printer at the time of uninstallation;

FIG. 9 is a flowchart illustrating a flow of operations of an uninstaller according to an application example; and

FIG. 10 is a diagram illustrating an example of a selection screen for selecting a new default printer at the time of uninstallation according to the application example.

### DETAILED DESCRIPTION

Hereinafter, a device managing system and a program according to an embodiment of the invention will be described with reference to the accompanying drawings. In this embodiment, the invention is applied to a device managing system and a program including printers as devices and a PC as a controller thereof and managing a default device set in the PC.

(System Configuration)

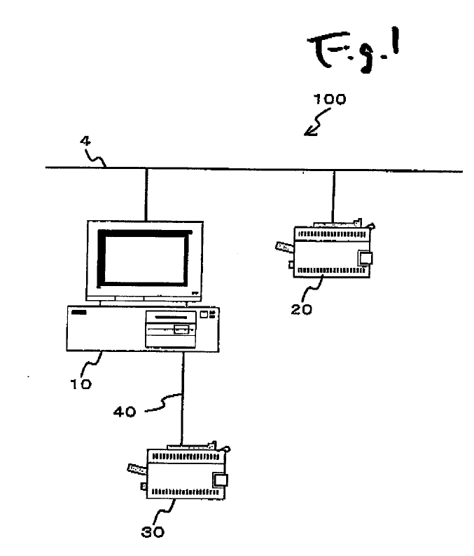

As shown in FIG. 1, a device managing system 100 according to an embodiment of the invention includes a PC 10 and printers 20 and 30. In the system 100, the PC 10 and the printer 20 are connected to each other through a network 4 such as a LAN. The PC 10 and the printer 30 are connected directly to each other through a printer cable 40.

As shown in FIG. 1, the PC 10 can use plural printers. That is, printer drivers for usable printers are installed in the PC 10 and the PC 10 can output printing commands to the printers. The PC 10 is connected to the printers 20 and 30 in FIG. 1, but the PC 10 may be connected to other printers than the printers 20 and 30. Plural printer drivers are installed in the PC 10.

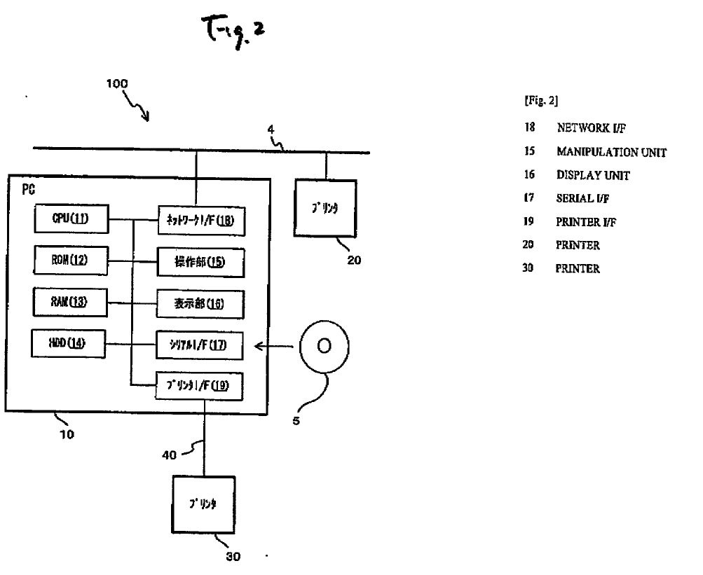

Specifically, as shown in FIG. 2, the PC 10 includes a CPU 11 performing various calculation processes, a ROM 12 storing activating programs (BIOS) performed by the CPU 11 at the time of activating the PC 10, a RAM 13 used as a temporary memory area at the time of allowing the CPU 11 to perform various processes, and a hard disk drive (HDD) 14 storing various programs or data.

The PC 10 further includes a manipulation unit 15 including a keyboard and a mouse, a display unit 16 including a liquid crystal display, etc., a serial port interface 17 exchanging signals with other information devices such as a CD-ROM drive, a network interface 18 exchanging signals through a network such as a LAN and Internet, and a printer port interface 19 exchanging signals with the printers.

An operation System (OS), printer drivers controlling the printers 20 and 30, and various applications such as a word processor and spreadsheet software are installed in the HDD 14 of the PC 10. As a function of the OS installed therein, a default printer can be set.

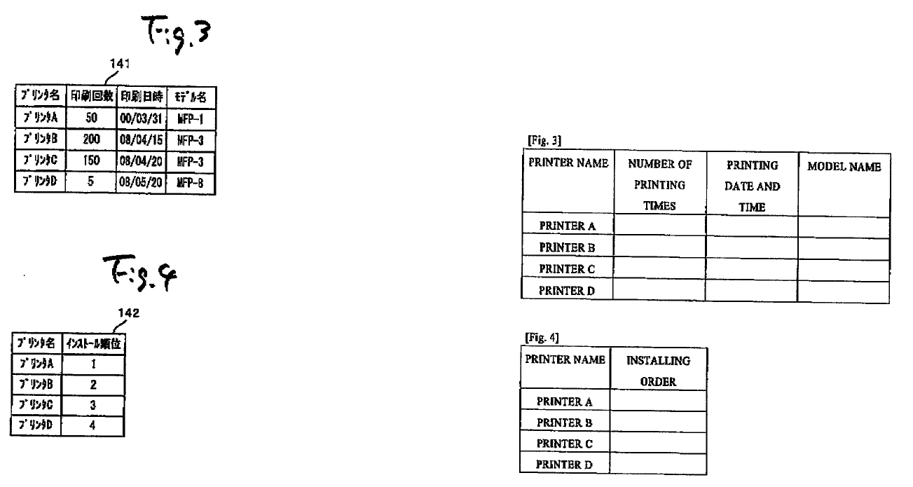

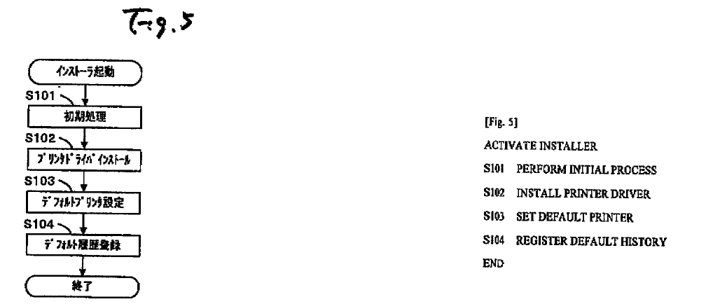

The HDD 14 of the PC 10 includes a database 141 storing a history of utilizing printers and a database 142 storing a history of setting printers as a default printer. Specifically, as shown in FIG. 3, printer names for identifying the printers, the number of printing times, printing dates and times, and printer model names are stored in the database 141. As shown in FIG. 4, printer names for identifying the printers and installing order of the printers are stored in the database 142.

The number of print job processing times in the corresponding printer is recorded in the “number of printing times” and the final printing date and time of the corresponding printer is recorded in the “printing date and time”, in the database 141. The order of the printer driver installed in the PC 10 is recorded in the “installing order” in the database 142, where a greater number means a newer installed printer driver. These days, a printer driver is automatically set to a default printer at the time of installing the printer driver. Accordingly, the installing order can be considered as an order in which it is set as the default printer. Hereinafter, the “number of printing times” and the “printing date and time” are referred to as a “print history” and the “installing order” is referred to as a “default history.”

The print history in the database 141 is added or updated by the printer drivers every printing process. That is, the printer driver newly registers a printer when the corresponding printer is not registered in the database 141 after performing a printing process. On the other hand, when the printer is registered, 1 is added to the “number of printing times” and the print end time is recorded in the “printing date and time.” A monitoring program may add or update the print history in the database 141 instead of the printer driver. The default history in the database 142 is added or deleted every installation or uninstallation.

(Default Printer Setting Operation)

A default printer setting operation of the PC 10 will be described now. The default printer can be automatically set at the time of installing or uninstalling a printer driver, as well as being manually set by a user using a utility program provided from the OS. An automatic default printer setting operation of an installer and an uninstaller in a printer driver will be described now.

(Installer)

First, an operation of the installer will be described with reference to the flowchart shown in FIG. 5. The installer according to this embodiment is stored in the CD-ROM 5 (see FIG. 2) and is executed by the serial interface 17 of the PC 10. The installer may be downloaded from a server of a maker through the Internet or may be stored in a storage medium other than the CD-ROM 5.

First, an initialization process for preparing the installation such as a language selecting process, a mode selecting process, and an interface selecting process is performed (S101). Thereafter, the printer driver installing process is performed (S102).

Then, a printer to be installed is set as a default printer of the PC 10 (S103). The printer is newly recorded in the default history in the database 142 (S104). That is, the record of which the “installing order” is the highest is added to the database 142. This flow is ended after the process of S104.

(Uninstaller)

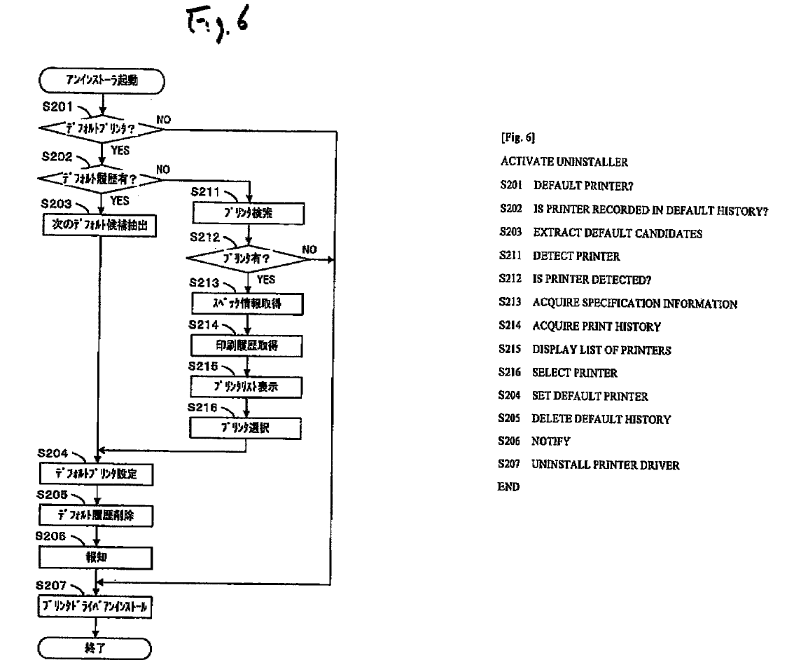

An operation of the uninstaller will be described with reference to the flowchart shown in FIG. 6. The uninstaller according to this embodiment is installed in the PC 10 at the time of installation and is executed from the HDD 14.

The uninstaller may be downloaded from a server of a maker through the Internet or may be stored in a storage medium such as the CD-ROM 5 (see FIG. 2).

First, it is determined whether a printer to be uninstalled is a default printer (S201). When the printer to be uninstalled is not the default printer (NO in S201), it is not necessary to change the default printer. Accordingly, the printer driver to be uninstalled is uninstalled (S207) and this flow is ended.

On the other hand, when the printer to be uninstalled is the default printer (YES in S201), it is necessary to change the default printer. Therefore, it is first determined whether a printer other than the printer to be uninstalled is recorded in the default history in the database 142 (S202).

When a printer is recorded in the default history (YES in S202), a default candidate to be set as a new default printer is extracted on the basis of the default history (S203). Specifically, in this embodiment, the “installing order” is used as an indicator, and a printer lately set as the default printer (that is, a printer having the highest value of the “installing order” other than the printer to be uninstalled) is extracted.

After extracting the default candidate, the default candidate is set as the default printer of the PC 10 (S204). Then, the default history of the printer to be uninstalled is deleted from the database 142 (S205). The print history of the printer, which corresponds to the default history, is also deleted.

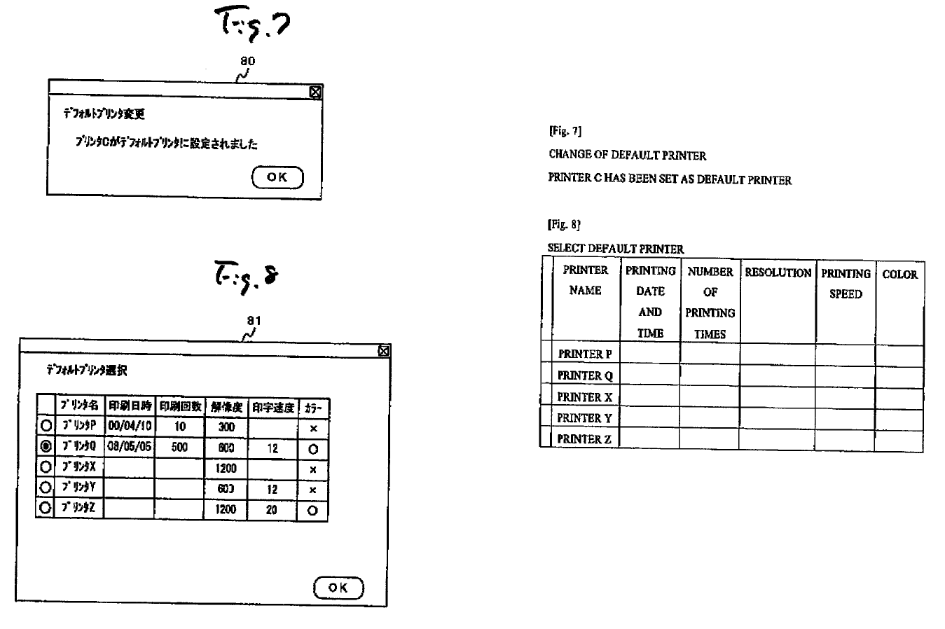

Thereafter, a message indicating that the default printer is changed is displayed on the display unit 16 (S206). For example, as shown in FIG. 7, the message indicating that the default printer is changed is displayed in a message box 80 along with the printer name set as the default printer. By notifying the new default printer, a user can grasp the fact that the default printer is automatically set. The means for performing the notification is not limited to the display of a message. For example, the notification may be performed using sound. After the user inputs the check of the message, the printer driver is uninstalled (S207). After the uninstallation, this flow is ended.

On the other hand, when a default history is not recorded in the database 142 (no printer is recorded in the default history) (NO in S202), the printer drivers installed in the PC 10 are detected (S211). That is, even when no printer is registered in the database 142, a printer not included in this system (that is, printer of which the default history is not added at the time of installation, for example, an old-model printer or a printer made by other makers) may be installed in the PC. Therefore, the printers are first detected so as to select the printer as the default printer. The detection of the printers can be performed using a related-art technique provided from the OS.

Then, it is determined whether a printer driver other than a printer driver of the printer to be uninstalled is detected (S212). When no printer driver is detected (NO in S212), it is not possible to extract the default candidate. Therefore, the processes subsequent to S213 are bypassed, the printer driver to be uninstalled is uninstalled (S207), and this flow is ended.

On the other hand, when a printer is detected (YES in S212), specification information on the detected printer is acquired (S213). The specification information includes, for example, a resolution, a printing speed, and color/monochrome information. The specification information is acquired on the basis of the model name of the detected printer by accessing a server storing specification information on plural models of plural makers. The specification information may be acquired from the OS, when the OS stores the specification information. The specification information may be stored in the CD-ROM 5 and may be acquired by requesting for insertion of the CD-ROM 5 at the time of detection. Alternatively, the specification information may be stored in the uninstaller and may be acquired therefrom.

Then, the print history of the detected printer is acquired from the database 141 (S214). In the process of S214, for example, when a printer driver of which the print history is added but the default history is not added is detected, the print history of the printer can be acquired.

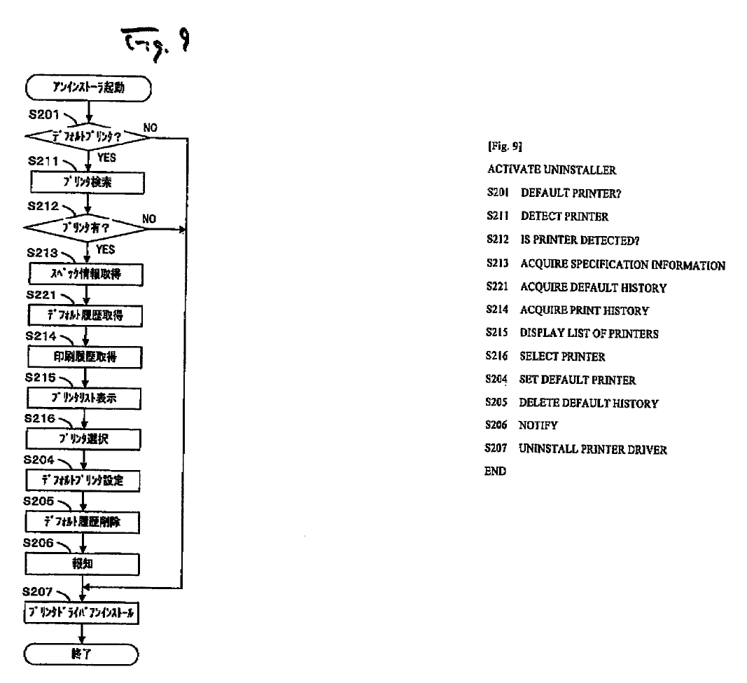

Then, the detected printer is displayed in the list on the display unit 16 (S215). As shown in FIG. 8, a dialog 81 including the specification information acquired in S213 and the print history acquired in S214 along with a printer name for identifying the printer is displayed in the list. The specification information and the print history serve as a reference for allowing a user to select a new default printer in S216. The specification information and the print history not acquired are left in black.

One printer is selected as a default candidate from the displayed list of printers (S216). The selection of printer is performed by a user's input. Thereafter, the selected printer is set as the default printer (S204). Then, the processes of S205 to S207 are sequentially performed and then this flow is ended.

That is, in the uninstaller according to this embodiment, the default candidate is extracted on the basis of the default history, and the default candidate is automatically set as the new default printer. Here, the new default printer may be automatically set on the basis of the default history without the extraction of lie default candidate. When no printer is recorded in the default history, all the printers connected to the PC 10 are detected and the specification information and the print history of each of the detected printers are acquired. The default printer is manually set by allowing a user to select one default candidate from the detected printers.

The indicator for extracting the default candidate in the processes of S202 and S203 is not limited to the “installing order” of the default history. For example, a printer having lately performed a printing operation may be extracted as the default candidate using the “printing date and time” of the print history. A printer having the maximum number of printing times may be extracted as the default candidate using the “number of printing times” of the print history. When the “number of printing times” is used as an indicator, it can be considered that the numbers of printing times of some printers have the same value and thus one printer is not determined. In this case, the “printing date and time” may be used as a second indicator. When the specification information such as a resolution, a printing speed, and color/monochrome information is stored in the database 141 or the specification information can be acquired from the OS, one of the specifications may be used as the indicator. The number of indicators for the extraction is not limited to one, but plural indicators may be set.

When plural default candidates are extracted, it cannot be determined what default candidate should be set as a new default printer. In an example where plural default candidates are extracted, plural indicators for extracting the default candidate are set and different printers are extracted on the basis of the indicators. Specifically, the “number of printing times” and the “printing date and time” are set as the indicators for extracting the default candidate, printer B is extracted on the basis of the “number of printing times” and printer C is extracted on the basis of the “printing date and time.” When the “number of printing times” is set as the indicator and plural printers having the same indicator value exist, the number of default candidates is plural. In this way, when the number of printers determined as the default candidate is not one, the default candidates are displayed and the user is allowed to select one default candidate, as described in S215 and S216. That is, the default candidate is automatically set as a new default candidate when the number of default candidates is determined as one, and the user is inquired and one default candidate is manually set by the user when the number of default candidates is not determined as one.

(Application Example of Uninstaller)

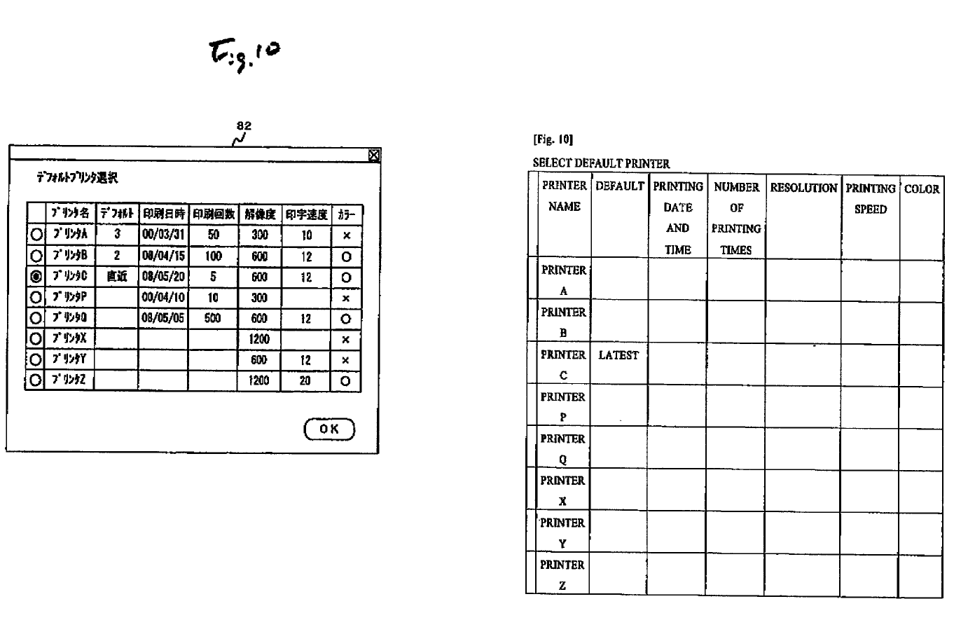

An application example of the uninstaller will be described now with reference to the flowchart shown in FIG. 9. The uninstaller according to the application example displays a list of printers connected to the PC 10 and allows the user to select a printer as a new default printer, regardless of the details stored in the databases 141 and 142. Accordingly, this example is different from the above-mentioned embodiment in which the default printer is automatically set without inquiring the user when a default history is stored (when a printer is recorded in a default history). In the flowchart shown in FIG. 9, the same processes as the above-mentioned embodiment are denoted by the same reference numerals.

It is first determined whether an object to be uninstalled is a default printer at that time (S201). When the object is the default printer (YES in S201), printers connected to the PC 10 are detected (S211). Accordingly, all the printers connected to the PC 10 are detected, whether information on them are stored in the databases 141 and 142.

Then, when printers other than the printer to be uninstalled are detected (YES in S212), the specification information on each of the detected printers is acquired (S213). The default history of each of the detected printers is acquired from the database 142 (S221). The print history of each of the detected printers is acquired from the database 141 (S214). Thereafter, as shown in FIG. 10, a dialog 82 in which the printers detected in the process of S211 are arranged along with the respective information acquired in the processes of S213, S221, and S214 is displayed (S215).

One printer is selected from the displayed list of the detected printers (S216). The selection of printer is performed in accordance with the user's input. Then, the selected printer is set as the default printer (8204). Thereafter, the processes of S205 to S207 are sequentially performed and this flow is ended.

That is, in the uninstaller according to this application example, the printers connected to the PC 10 are detected and the print history, the default history, and the specification information of each of the detected printers are acquired. Then, the detected printers are displayed in a list along with the acquired information, and one printer is manually selected from the printers and set as the default printer.

As described in the above, in the uninstaller of the device managing system 100, the default history which shows an order in which the printers are set as the default printer is acquired from the database 142 at the time of setting the default printer. By using the default history as an indicator, one printer is determined as a new default candidate and the default candidate is automatically set as the new default printer. Accordingly, it is possible to simply set the default printer without the user's labor. The indicator for determining a default candidate is not limited to the default history, but may employ the print history which includes the number of printing times and the final printing date and time (utilization record) or the specification information which includes the resolution and the printing speed (specification information). In this way, since one of the default history and the like is used as the indicator for setting the new default printer, it is possible to set a proper device (printer).

When no default history exists (no printer is recorded in the default history), that is, when the number of default candidates is not determined as one, the list of the default candidates is displayed, the user is allowed to select one default candidate therefrom, and the selected default candidate is set as the default printer. Accordingly, the default printer can be set manually. That is, this system can perform the automatic default setting and the manual default setting and is very convenient for a user. The print history or the specification information of printers is displayed at the time of selecting the printer. This information serves as a reference for determination at the time of manually setting the default printer. Therefore, the user's burden is reduced at the time of selecting a printer.

In the device managing system 100, it is preferable that when it is instructed to uninstall a first printer being set as the default device, a second printer different from the first printer is selected and the selected second printer is set as the default printer. That is, at the time of uninstalling the default printer, it is much necessary to set a new default device. In this way, the present invention is suitable for a case where a new default device should be selected.

The above-mentioned embodiment and application example of the embodiment are only examples of the present invention and thus do not limit the invention. Accordingly, the invention can be modified in various forms without departing from the gist of the invention. For example, the default printer is set in the embodiment and application example, but the default setting is not limited to the printer. That is, the default object may be a device such as a scanner controlled by an information apparatus such as a PC. The printer drivers are installed in the PC in the embodiment and application example, but the invention is not limited to the PC. For example, the printer drivers may be installed in a work station, a mobile information terminal, and the like.

The setting of the default printer is performed at the installation and uninstallation in the embodiment and the application example, but the setting of the default device is not limited to it. For example, a default printer setting button may be disposed in the utility software of a printer driver and the setting of the default printer may be performed in response to the pressing of the button.

In the embodiment and application example, the “installing order” which is the utilization history as a default device is stored in the database 142 and the “number of printing times” and the “printing date and time” which are the device utilization record are stored in the database 141, but the invention is not limited to them. For example, “resolution”, “printing speed”, “color correspondence” which are the device specification information may be stored therein. In this case, the specification information may be used as an indicator for determining the default printer.

The default history and the print history are recorded in the embodiment and the application example, but both histories need not be necessarily recorded. That is, the number of indicators for determining a new default device can be at least one. Therefore, when some recorded information is omitted, the new default device may be determined using the other defined information.

In the embodiment and application example, the database 141 manages the print history and the database 142 manages the default history. However, if the histories are managed by the OS, the histories may be acquired from the OS.

While the present invention has been shown and described with reference to certain exemplar embodiments thereof, it will be understood by those skilled in the art that various changes in form and details may be made therein without departing from the spirit and scope of the invention as defined by the appended claims.

What is claimed is:

1. A device managing system, comprising:
a storage unit configured to store management information on at least two devices, the management information including at least one of a history of utilizing as a default device, specification, and a record of use;
a determination unit configured to acquire the management information, and configured to determine a default candidate from the devices based on an indicator included in the acquired management information; and
a setting unit configured to set the determined default candidate as a default device.

2. The device managing system according to claim 1, further comprising:
a notification unit configured to notify the default device set by the setting unit.

3. The device managing system according to claim 1, further comprising:
a selection unit configured to display identification information of the devices together with the management information, and configured to allow a user to select one of the devices; and
a manual setting unit configured to set the selected one of the devices as the default device.

4. The device managing system according to claim 3,
wherein when the default candidate determined by the determination unit includes a plurality of devices, one of the plurality of devises is selected by the selection unit.

5. The device managing system according to claim 1,
wherein the at least two devices include a first device being set as the default device and a second device different from the first device, and
wherein when it is instructed to uninstall a driver corresponding to the first device, the determination unit determines the second device and the setting unit sets the second device as the default device.

6. A device managing system comprising:
a storage unit configured to store management information on at least two devices, the management information including at least one of a history of utilizing as a default device, specification, and a record of use;
a selection unit configured to acquire the management information, and configured to display identification information of the devices together with the management information, the selection unit configured to select one of the devices; and
a manual setting unit configured to set the selected one of the devices as the default device.

7. A computer-readable medium having a computer program stored therein and readable by a computer, the computer program, when executed by the computer, causing the computer to perform operations comprising:
acquiring the management information on at least two devices, the management information including at least one of a history of utilizing as a default device, specification, and a record of use;
determining a default candidate from the devices based on an indicator included in the acquired management information; and
setting the determined default candidate as a default device.

8. A computer-readable medium having a computer program stored therein and readable by a computer, the computer program, when executed by the computer, causing the computer to perform operations comprising:
acquiring the management information on at least two devices, the management information including at least one of a history of utilizing as a default device, specification, and a record of use;
displaying identification information of the devices together with the management information;
selecting one of the devices; and
setting the selected one of the devices as the default device.

9. A device managing system comprising:
a storage unit configured to store management information on at least two devices, the management information including at least one of a history of utilizing as a default device, specification, and a record of use; and
a setting unit configured to acquire the management information, configured to set one of the devices as a default device based on an indicator included in the acquired management information.

10. The device managing system according to claim 9, further comprising:
a notification unit configured to notify the default device set by the setting unit.

11. The device managing system according to claim 9,
wherein the at least two devices include a first device being set as the default device and a second device different from the fist device, and
wherein when it is instructed to uninstall a driver corresponding to the first device, the setting unit sets the second device as the default device.
